(19) United States
(12) Patent Application Publication
(10) Pub. No.: US 2009/0132289 A1
(43) Pub. Date: May 21, 2009

(54) SYSTEM AND METHOD FOR FACILITATING HEALTH SAVINGS ACCOUNT PAYMENTS

(75) Inventors: Pamela J. Stenman, Winsted, CT (US); John Scott Pierson, East Hampton, CT (US); Heather D. Kiersznowski, Windsor, CT (US); David Kiersznowski, JR., Windsor, CT (US); Andrew Hill, Wallingford, CT (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Aetna Inc., Hartford, CT (US)

(21) Appl. No.: 11/943,473

(22) Filed: Nov. 20, 2007

(51) Int. Cl. G06Q 40/00; G06Q 20/00

(52) U.S. Cl. 705/4; 705/44

(57) ABSTRACT

Ways are provided for a health care organization (HCO) to facilitate payments from a tax-advantaged medical savings account, such as an HSA account, in conjunction with claim processing, by way of automatically debiting an HSA account and providing an integrated claim payment adjustment functionality to eliminate underpayments and/or overpayments for the HSA and health plan balances. A claim processing module reprocesses the claim to adjust the respective balances in one or more of the following ways: (a) HCO crediting the HSA account to eliminate the overpayment from the HSA, (b) HCO issuing a collection request to the health care provider to adjust for overpayment of the HCO balance, (c) HCO issuing a second payment to the health care provider to adjust for the underpayment of the HCO balance, and (d) HCO rebalancing the member and HCO-responsible portions of the claim.

### FIELD OF THE INVENTION

This invention relates generally to the field of health insurance and more specifically to the area of health care payment processing.

### BACKGROUND OF THE INVENTION

In the United States, various forms of tax-advantaged medical savings accounts are becoming available for consumers with the advent of consumer driven health care. These accounts typically provide tax-free distributions to cover qualified expenses for health care related products and services incurred by a consumer. Qualified medical expenses include patient-responsible balances of medical claims, office visit and pharmacy co-pays, over-the-counter medication charges, as well as a number of other health care related expenses incurred by the consumer, his or her dependents, and family.

A Health Savings Account (HSA) type of medical savings account accompanies a high-deductible health plan (HDHP). An HSA accountholder's contributions to the HSA account have the added benefit of reducing the accountholder's taxable income. The consumer deposits the savings in an interest-bearing savings account or an investment account at a financial institution, such as a bank, where the earnings grow tax-deferred and health care related distributions are tax-free. Additional types of tax-advantaged medical savings accounts include flexible spending accounts (FSA) and health reimbursement arrangements (HRA), each with its own contribution, distribution, and rollover rules and associated tax implications. For example, unlike HSA contributions, FSA deposits must be used by the end of a plan year to avoid forfeiture. Similarly, unlike HSA contributions, HRA contributions may only be rolled over between health plans under certain conditions.

In a typical payment transaction associated with health care related charges covered under a health plan, a health care provider bills the consumer's insurance company for the accumulated balance. Optionally, the consumer may pay a known co-payment at the time of the transaction. Upon receiving the payment for the covered portion of the balance, the health care provider bills the consumer for the remainder of the charges, which the consumer may elect to pay using his or her HSA funds. It is up to the consumer to ensure that the transaction is HSA-eligible and to initiate payment from the HSA account administered by the financial institution. Consequently, consumer's mistakes in HSA eligibility determinations may result in assessment of taxes and additional penalties for the non-eligible HSA payments. Billing and claim processing mistakes further exacerbate the problem because the consumer has to deal with the health plan for reprocessing the claim and then separately interface with the health care provider for requesting a refund for overpayment of the member portion of the claim that they may have paid using HSA funds, and potentially the financial institution to redeposit HSA funds, or to provide the health care provider with additional HSA funds when a reprocessed claim indicates an underpayment from the HSA account. While some health plans include an automatic claim forwarding feature, such plans do not ascertain HSA eligibility and/or lack capability to integrate HSA payment adjustments.

### BRIEF SUMMARY OF THE INVENTION

Embodiments of the invention are used to provide an integrated system and method for a health care organization (HCO) to facilitate payments from a tax-advantaged medical savings account, such as an HSA account, in conjunction with claim processing, by way of automatically debiting a health plan member's HSA account for the HSA-eligible portion of the patient-responsible balance of the claim, transmitting a combined payment to a health care provider, and providing an integrated claim payment adjustment functionality by interfacing with the HSA and health care provider accounts to correct underpayments and/or overpayments for the HSA and health plan portions of the claim.

Preferably, the health care plan is a high deductible health insurance plan (HDHP) compatible with a tax-advantaged medical savings account, such as a health care savings account (HSA). To obtain payment for the outstanding balance of a transaction, a health care provider (or a third-party billing service provider) uses a medical billing application to query a medical database for the outstanding balance and the associated transaction information in order to generate a claim for payment by the HCO. Preferably, the health care provider transmits the claim in electronic format via a network to a claim processing module of the HCO for adjudicating the claim in accordance with the terms of the member's health care plan.

The claim processing module comprises one or more server computers each having a computer readable medium, such as a hard disk, an optical disk, and/or flash memory, and storing computer executable instructions for processing the claim, interfacing with the financial institution for automatically debiting payments from and crediting payments to the HSA account, making combined payments to the health care provider, and making the necessary adjustments to the HSA and/or health plan portion of the combined payments.

In an embodiment, the claim processing module adjudicates the claim in accordance with the benefit limits and conditions specified in the health care plan to allocate the balance due to the health care provider between the member and the HCO. If the description of charges within a claim indicates an HSA-eligible transaction that is related to health care products or services, the HCO automatically debits the HSA account by issuing a request to the financial institution to transfer the member's portion of the balance from the HSA account to the HCO. In one embodiment, the HCO administers an internal HCO account for issuing payments to the health care provider and for accepting payment from the financial institution. The HCO combines the HSA funds corresponding to the member-responsible balance portion of the claim with the applicable HCO balance of the claim and forwards the combined payment to the health care provider's account. The HCO issues an Explanation of Benefits (EOB) statement to the member and preferably an Electronic Remittance Advice (ERA) or a paper EOB to the health care provider detailing the combined payment.

In a preferred embodiment, to further facilitate the payment resolution in situations when the HCO receives an adjustment request with respect to the HCO's balance or the member-responsible balance of the combined payment, the HCO reprocesses the claim to adjust for the overpayment and/or underpayment of the respective balances and automatically credits the HSA account when the reprocessed claim indicates an overpayment from the member's HSA account (i.e., when the HCO debited excess funds from the HSA). Depending on the delay between the combined payment and the adjustment request, the member may have already satisfied an increased member balance directly with the health care provider. Therefore, when the reprocessed claim indicates an underpayment from the member's HSA account (i.e., additional member responsibility for the claim), the HCO preferably foregoes debiting the member's HSA account for the additional funds in order to avoid the possibility of double payment of the member-responsible balance to the health care provider. In this case, the health care provider bills the member for the additional member balance.

Depending on the overpayment or underpayment with respect to the HCO and member balances of the combined payment, the adjustment results in reprocessing of the claim to adjust the respective balances in one or more of the following ways: (a) HCO crediting the health plan member's HSA account to eliminate the overpayment from the HSA, (b) HCO issuing a collection request to the health care provider to adjust for overpayment of the HCO portion of the claim, (c) HCO issuing a second payment to the health care provider to adjust for the underpayment of the HCO portion of the claim, and (d) HCO rebalancing the member and HCO-responsible portions of the claim. In an alternate embodiment, the HCO 100 automatically debits the HSA account and forwards an additional HSA payment to the health care provider when the reprocessed claim indicates an underpayment from the member's HSA account.

Upon adjusting the respective payment balances, the HCO 100 issues a second EOB detailing the adjusted payments, including any applicable credits to or debits from the member's HSA account. A single EOB detailing automatic payments from and credits to the HSA account provides for a seamless payment transaction and presents the member with a complete view of his or her health care finances.

In one aspect of the invention, a method is provided for administering payments under a health plan by a health care organization, the health plan associated with a financial account administered by a financial institution for a health plan member for making health care related payments, the method comprising receiving a medical claim associated with the health plan member, the medical claim comprising a description of charges, determining a first amount comprising the health care organization's responsibility for payment for the medical claim under the health plan, determining a second amount comprising the health plan member's responsibility for payment for the medical claim under the health plan, interfacing with a financial institution for sending an electronic request to debit the health plan member's financial account for the second amount when the description of charges relates to at least one of medical products and medical services, in response to electronically receiving the second amount from the financial institution, issuing a first payment for the medical claim to a health care provider, the payment including the first and second amounts, receiving an adjustment request to adjust the first payment due to at least one of an overpayment and an underpayment associated with at least one of the first and second amounts, and in response to the adjustment request, adjusting at least one of the first and second amounts to eliminate the overpayment and the underpayment by interfacing with the financial institution.

In another aspect of the invention, a system is provided for administering payments under a health plan by a health care organization, the system comprising a financial account administered by a financial institution for a health plan member, the financial account adapted for making health care related payments, a claim processing module associated with the health care organization, the claim processing module capable of interfacing with the financial account for sending a request to electronically debit the financial account for the health plan member's responsibility for a payment in connection with a medical claim under the health plan and adjusting at least the health plan member's responsibility for the payment to eliminate at least one of an overpayment and an underpayment associated with the health plan member's responsibility for the payment by transferring funds in and out of the financial account.

In yet another aspect of the invention, a computer readable medium is provided, the computer readable medium having stored thereon computer executable instructions for administering payments under a health plan by a health care organization, the health plan associated with a financial account administered by a financial institution for a health plan member for making health care related payments, the instructions comprising receiving a medical claim associated with the health plan member, the medical claim comprising a description of charges, determining a first amount comprising the health care organization's responsibility for payment for the medical claim under the health plan, determining a second amount comprising the health plan member's responsibility for payment for the medical claim under the health plan, interfacing with a financial institution for sending an electronic request to debit the health plan member's financial account for the second amount when the description of charges relates to at least one of medical products and medical services, in response to electronically receiving the second amount from the financial institution, issuing a first payment for the medical claim to a health care provider, the payment including the first and second amounts, receiving an adjustment request to adjust the first payment due to at least one of an overpayment and an underpayment associated with at least one of the first and second amounts, and in response to the adjustment request, adjusting the at least one of the first and second amounts to eliminate the overpayment and the underpayment by interfacing with the financial institution.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 illustrates an implementation of a system representing a payment processing environment associated with health care related products and services as contemplated by an embodiment of the present invention;

FIG. 2 is a flowchart illustrating a method of combining claim and HSA processing, including making combined payments and accommodating payment adjustments by a claim processing module of FIG. 1, in accordance with an embodiment of the invention; and

FIG. 3 is a flowchart illustrating the payment adjustment process performed by the claim processing module of FIG. 1, in accordance with an embodiment of the invention.

### DETAILED DESCRIPTION OF THE INVENTION

The following examples further illustrate the invention but, of course, should not be construed as in any way limiting its scope.

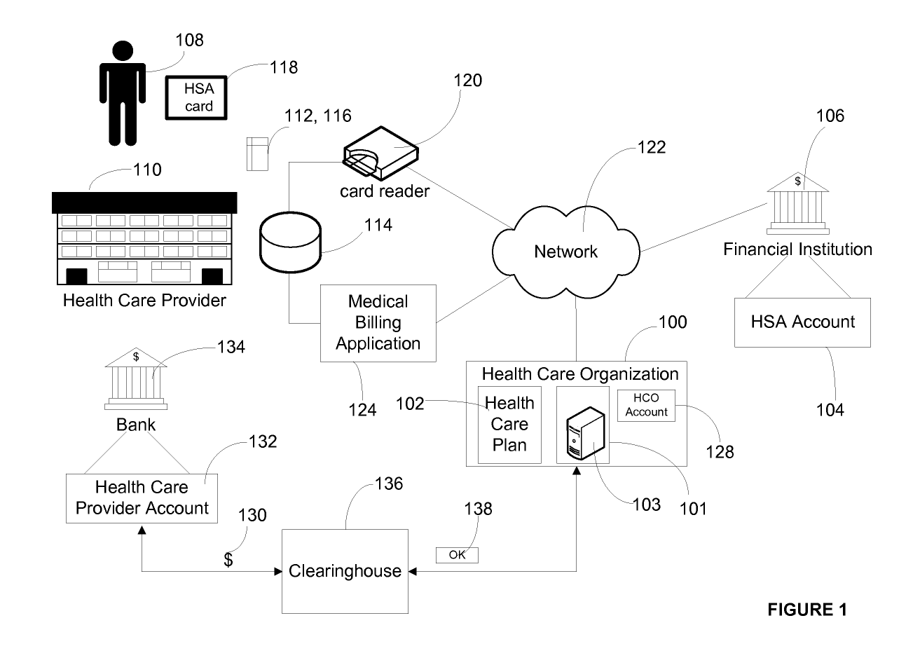

Turning to FIG. 1, an implementation of a system contemplated by an embodiment of the invention is shown with reference to a payment processing environment associated with health care related products and services, wherein a health care organization facilitates seamless transactions by automatically debiting and crediting a health plan member's tax-advantaged financial account in connection with payments and payment adjustments for the health care related products and services. In one embodiment, the health care organization (HCO) 100 is an insurance company that administers a health care plan 102. Preferably, the health care plan 102 is a high deductible health insurance plan (HDHP) compatible with a tax-advantaged medical savings account, such as a health care savings account (HSA) 104. Alternatively, the health care plan 102 is compatible with a different type of tax-advantaged medical savings account, such as a health reimbursement arrangement (HRA), a flexible spending account (FSA), or any other savings account eligible for preferred tax treatment of health care related purchases. The HSA account 104 is administered by a financial institution 106, such as a bank or an investment brokerage.

When a health plan member 108 purchases health care related products or services from a health care provider 110, the health care provider 110 stores the associated transaction information 112 in a medical billing database 114. The medical billing database 114 comprises a computer readable medium, such as a hard disk, an optical disk, or flash memory for storing the transaction information 112. In one embodiment, the medical database 114 is collocated with the health care provider 110. Alternatively, the medical database 114 is administered by a third-party medical billing service provider. The transaction information 112 comprises medical claim information 116 specifying the nature of products or services received from the health care provider 110, the time and date of the transaction, a total amount of the charges accumulated for the products or services during the transaction, as well as the amount received from the plan member 108, such as in a form of a co-payment under the health care plan 102. In one embodiment, the transaction information 112 comprises Stock Keeping Unit (SKU) information associated with specific medical products purchased from the health care provider 110, such as a drug store or a pharmacy, and/or Merchant Category Code (MCC) information for classifying the type of product or service involved in the transaction. In an embodiment, the member 108 uses a debit card, such as an HSA card 118, to satisfy a known co-payment (e.g., as indicated on the back of a health insurance card) for the medical products or services received from the health care provider 110. In this case, the health care provider 110 uses a point-of-sale card reader 120 to record the co-payment amount at the medical database 114 and to initiate a payment request for the co-payment directly from the member's HSA account 104 via a network 122. Upon confirming the availability of funds in the HSA account 104, the financial institution 106 forwards the co-payment amount to the health care provider 110.

To obtain payment for the outstanding balance of the transaction, the health care provider 110 (or a third-party billing service provider) uses a medical billing application 124 to query the medical database 114 for the remaining balance and the associated transaction information 112 in order to generate a claim 126 for payment by the HCO 100. Preferably, the health care provider 110 transmits the claim 126 in electronic format via a network 126 to a claim processing module 101 of the HCO 100 for adjudicating the claim 126 in accordance with the terms of the member's health care plan 102, such as by employing a business rules engine application. The claim processing module 101 comprises one or more server computers 103 each having a computer readable medium, such as a hard disk, an optical disk, and/or flash memory, and storing computer executable instructions for processing the claim 126, interfacing with the financial institution 106 for automatically debiting payments from and crediting payments to the HSA account 104, making combined payments to the health care provider 110, and making the necessary adjustments to the HSA and/or health plan portion of the combined payments.

Specifically, the claim processing module 101 adjudicates the claim 126 in accordance with the benefit limits and conditions specified in the health care plan 102 to allocate the balance due to the health care provider 110 between the member 108 and the HCO 100. If the description of charges within a claim 126 indicates an HSA-eligible transaction that is related to health care products or services, the HCO 100 automatically debits the HSA account 104 by issuing a request to the financial institution 106 to transfer the member's portion of the balance from the HSA account 104 to the HCO 100. In one embodiment, the HCO 100 administers an internal HCO account 128 for issuing payments to the health care provider 110 and for accepting payment from the financial institution 106. The HCO 100 combines the HSA funds corresponding to the member-responsible balance portion of the claim 126 with the applicable HCO balance of the claim and forwards the combined payment 130 to the health care provider's account 132 at the bank 134. Preferably, the HCO 100 forwards the combined payment 130 to the health care provider's account 132 via a clearinghouse 136. In one embodiment, the HCO 100 forwards the combined payment 130 via an electronic funds transfer (EFT). Alternatively, the HCO 100 generates a check in the amount of the combined payment 130 for the health care provider 110. Once the bank 134 receives the combined payment 130, it sends out an electronic payment confirmation 138. The HCO 100 issues an Explanation of Benefits (EOB) statement to the member 108 and preferably an Electronic Remittance Advice (ERA) or a paper EOB to the health care provider 110 detailing the combined payment 130.

In a preferred embodiment, to further facilitate the payment resolution in situations when the HCO 100 receives an adjustment request with respect to the HCO's balance or the member-responsible balance of the combined payment 130, the HCO 100 reprocesses the claim 126 to adjust for the overpayment and/or underpayment of the respective balances and automatically credits the HSA account 104 when the reprocessed claim 126 indicates an overpayment from the member's HSA account 104 (i.e., when the HCO 100 debited excess funds from the HSA 104). Depending on the delay between the combined payment 130 and the adjustment request, the member 108 may have already satisfied an increased member balance directly with the health care provider 110. Therefore, when the reprocessed claim indicates an underpayment from the member's HSA account 104 (i.e., additional member responsibility for the claim 126), the HCO 100 preferably foregoes debiting the member's HSA account 104 for the additional funds in order to avoid the possibility of double payment of the member-responsible balance to the health care provider 110. In this case, the health care provider 110 bills the member 108 for the additional member balance.

Depending on the overpayment or underpayment with respect to the HCO and member balances of the combined payment 130, the adjustment results in reprocessing of the claim 126 to adjust the respective balances in one or more of the following ways: (a) HCO 100 crediting the health plan member's HSA account 104 to eliminate the overpayment from the HSA 104, (b) HCO 100 issuing a collection request to the health care provider 110 to adjust for overpayment of the HCO portion of the claim, (c) HCO 100 issuing a second payment to the health care provider 110 to adjust for the underpayment of the HCO portion of the claim, and (d) HCO 100 rebalancing the member and HCO-responsible portions of the claim. In an alternate embodiment, the HCO 100 automatically debits the HSA account 104 and forwards an additional HSA payment to the health care provider 110 when the reprocessed claim 126 indicates an underpayment from the member's HSA account. In this scenario, in case of double payment to the health care provider 110 (e.g., by member 108 and by the additional HSA payment), the member 108 pursues a refund directly from the health care provider 110. Upon adjusting the respective payment balances, the HCO 100 issues a second EOB detailing the adjusted payments, including any applicable credits to or debits from the member's HSA account 104. A single EOB detailing automatic payments from and credits to the HSA account 104 provides for a seamless payment transaction and presents the member 108 with a complete view of his or her health care finances.

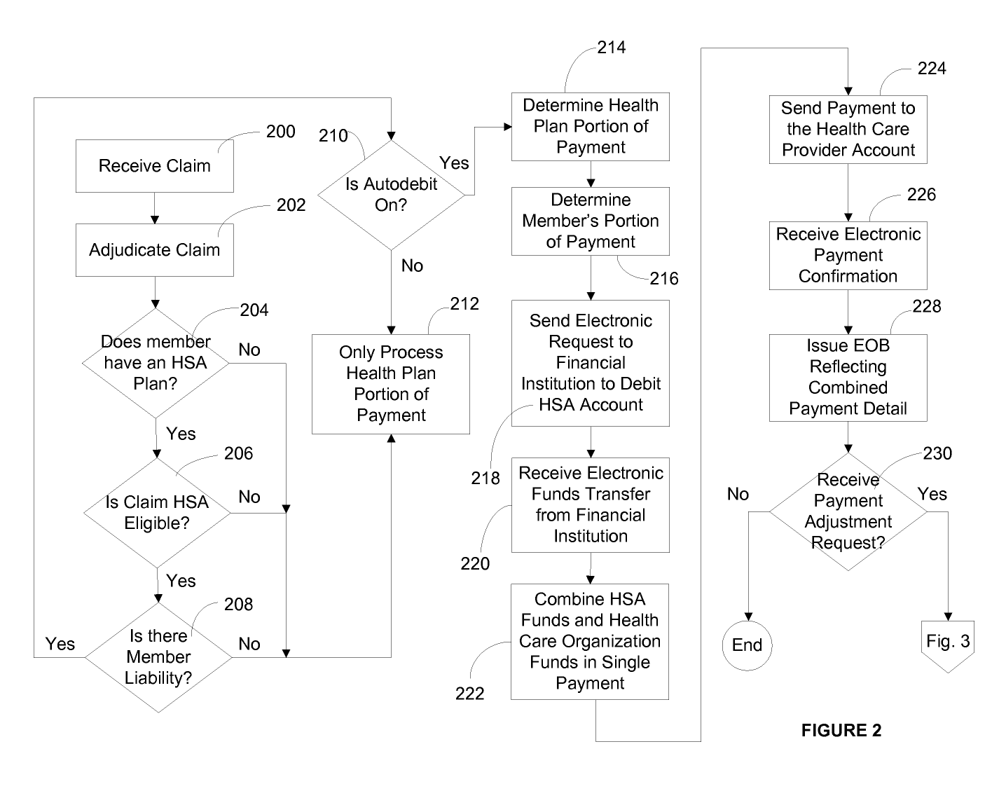

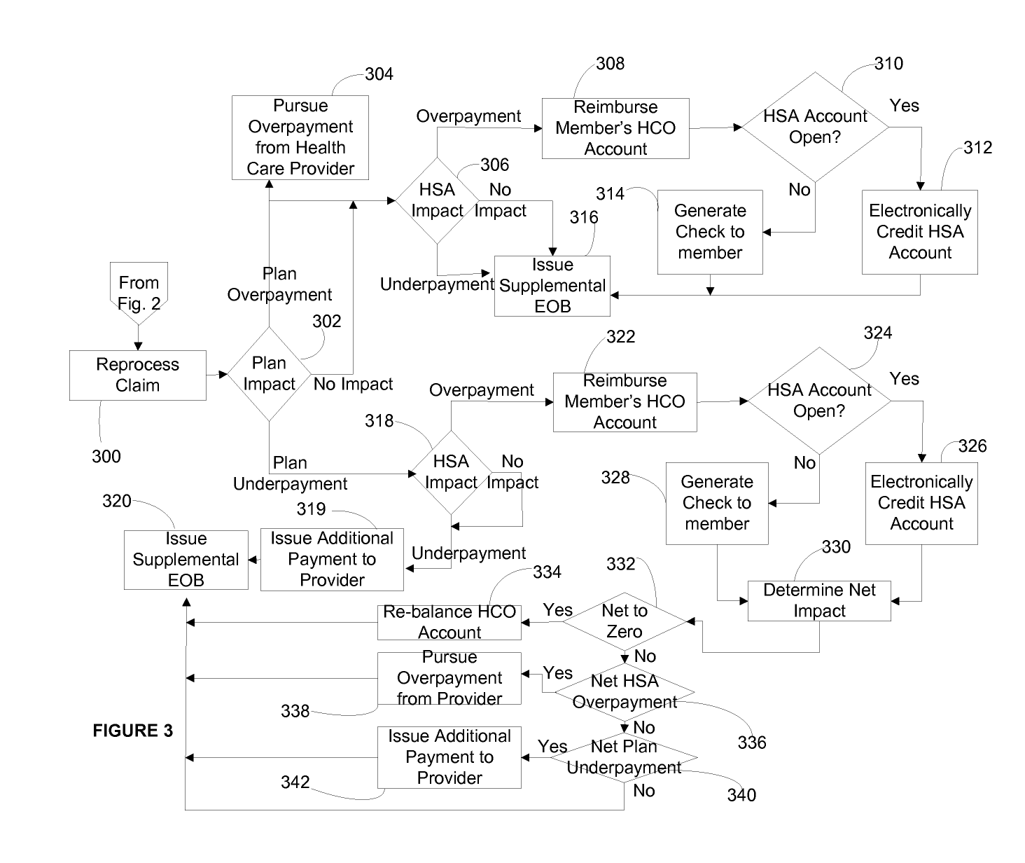

FIGS. 2 and 3 below illustrate an embodiment of a method of combining claim and HSA processing, including making combined payments and accommodating payment adjustments by a claim processing module 101 of the health care organization 100. Turning to FIG. 2, in step 200 the claim processing module 101 of the HCO 100 receives a claim 126 for payment under the health care plan 102. Preferably, the HCO 100 electronically receives the medical claim data 116 associated with the claim 126 via the network 122 and stores the medical claim data 116 in a database for subsequent analysis by the claim processing module 101. In step 202, the claim processing module 101 adjudicates the claim 126 for coverage eligibility under the health plan 102. Next, the claim processing module 101 determines whether the member 108 has an HSA account (e.g., by querying a database of member HSA accounts received from the financial institution 106), step 204. If so, in step 206, the claim processing module 101 determines whether the claim 126 is HSA-eligible, such as by parsing the description of products or services within the claim 126 to determine whether the claim is related to health care products or services (e.g., doctor visits, pharmacy purchases, etc). In one embodiment, the claim processing module 101 compares the SKU and/or MCC numbers optionally included in the transaction information 112 to a predetermined database of health care related SKU and/or MCC numbers for making the HSA eligibility decision. If the claim 126 is HSA-eligible, the HCO 100 next determines whether there is any remaining member responsibility under the claim, step 208, and if so, whether the HSA Autodebit feature of the member's health care plan 102 is activated, step 210. The HCO 100 activates the HSA Autodebit feature by accepting member input via an online interface, such as an online personal health record (PHR) or an online benefits management system, for activating the HSA automatic debit and credit functionality in connection with claim processing. Preferably, the HCO 100 is capable of processing member input for activating or deactivating the HSA Autodebit feature of the health care plan 102 throughout the plan year. If the answer to any of the steps 204-210 is in the negative, the claim processing module 101 only processes the health plan portion of the payment, step 212. Otherwise, in steps 214, 216, the claim processing module 101 apportions the outstanding claim balance between the HCO and the HSA account 104 by determining the respective HCO and member portions of the payment under the claim 126 in accordance with the benefit schedule of the health plan 102. In step 218, the claim processing module 101 initiates a request to the financial institution 106 to debit the member's HSA account 104 for the member-responsible portion of the claim balance. Preferably, the HCO 100 transmits an electronic request to debit the HSA 104 over a network 122.

The financial institution 106, in turn, determines the availability of funds in the HSA account 104 and sends full or partial payment to the HCO account 128, such as via an electronic funds transfer. Once the HCO 100 receives an electronic funds transfer for HSA portion of the claim balance, it combines the HSA funds with the HCO portion of the balance into a single payment for the health care provider 110, steps 220, 222. In steps 224, 226, the HCO 100 sends the combined payment to the health care provider 110 and receives an electronic payment confirmation via a clearing house 136.

Subsequent to the payment confirmation, the HCO 100 issues an ERA and/or EOB statement detailing the HCO and HSA portions of the combined payment, step 228. In step 230, if the HCO 100 receives a payment adjustment request, the claim processing module 101 initiates the payment adjustment process discussed in further detail in FIG. 3 below. Otherwise, the process ends.

Turning to FIG. 3, in response to a payment adjustment request, the HCO 100 initiates reprocessing of the claim via the claim processing module 101, step 300. In one embodiment, the payment adjustment request originates from a member 108, such as via a phone call to an HCO customer service representative. Alternatively or in addition, the adjustment request originates from a health care service provider 110 contacting the HCO 100, or based on a periodically conducted electronic audit of the HCO account 128. In step 302, the claim processing module 101 determines the impact on the HCO's portion of the payment in accordance with the health plan 102. If the claim processing module 101 identifies a plan overpayment, the HCO 100 pursues the overpayment amount of the HCO portion of the claim balance from the health care provider 110, step 304, and evaluates the impact on the HSA portion of the combined payment 130, step 306.

When the claim processing module 101 identifies an HSA overpayment, it reimburses the member's HCO account 128 for the extra funds debited from the HSA account 104, step 308. Next, the claim processing module 101 determines whether the member's HSA account 104 is still open, step 310. In an embodiment, the claim processing module 101 transmits an electronic request to the financial institution 106 to obtain status of the HSA account 104. If the HSA account 104 is active, the HCO 100 electronically credits the HSA account 104 in the amount of the HSA overpayment, such as via an EFT credit, step 312. If, however, the member's HSA account is no longer active, the HCO 100 generates a check in the amount of the HSA overpayment and forwards it to the member 108, step 314. Subsequently, in step 316, the claim processing module 101 generates a supplemental EOB detailing the adjusted portions of the balance. In case of an HSA overpayment, the supplemental EOB reflects the applicable HSA credit adjustment.

If, in step 306, the claim processing module 101 determines that the payment adjustment has no impact on the HSA portion of the claim balance, it generates a supplemental EOB (step 316) reflecting the adjusted plan portion of the claim balance. Preferably, if, in step 306, the claim processing module 101 identifies an underpayment from the HSA account 104 (i.e., additional member responsibility under the claim), it issues a supplemental EOB indicating the adjusted balances, including a plan overpayment and HSA underpayment amounts. In this case, the health care provider 110 separately pursues the additional HSA funds from the member 108 by billing the member for the balance of the HSA underpayment. This avoids possibility of double payment to the health care provider 110 in cases when the member 108 independently satisfies the HSA underpayment directly with the health care provider (e.g., by authorizing a debit using the member's HSA card 118). In another embodiment, the HCO 100 determines whether the HSA account 104 is active and automatically debits the underpayment amount from the HSA account 104.

Referring again to the plan impact analysis step 302, if the claim processing module 101 determines that the payment adjustment request has no impact on the health plan's portion of the combined payment 130, the process loops back to the HSA impact determination step 306 to determine the HSA overpayment, underpayment, or no HSA impact, as described in steps 308-316. If, in step 302, the claim processing module 101 identifies an underpayment from the HCO's portion of the claim balance (i.e., additional HCO responsibility), it determines the impact of the plan underpayment on the HSA portion of the claim balance in accordance with the health plan 102, step 318. If the change in the HSA portion of the claim balance is not required, or when the adjustment results in increased member responsibility (HSA underpayment), the claim processing module 101 issues an additional payment to the health care provider in the amount of the plan underpayment, step 319, and generates a supplemental EOB detailing the upward adjustment in the HCO and/or member balances, step 320. In case of HSA underpayment, the health care provider 110 balance bills the member 108 for the HSA underpayment amount.

In case of an HSA overpayment, the claim processing module records a credit in the member's HCO account 128 in the amount of the HSA overpayment, step 322. In step 324, the claim processing module 101 determines whether the HSA account 104 is open and, if so, automatically credits the member's HSA account 104 in the amount of the overpayment, such as via an EFT transfer, step 326. Otherwise, the claim processing module 101 generates a check for the member 108, step 328.

In step 330, the claim processing module 101 determines the net impact of the plan and HSA adjustments. If the net adjustment of the HSA and plan portions of the combined payment is zero, the claim processing module 101 simply re-balances or adjusts the respective balances to update the HCO account 128 and issues a supplemental EOB reflecting the new balances, steps 332, 334, 320. For example, the HCO 100 covered $20 from a $100 combined payment to the health care provider 110 and automatically debited the member's HSA account 104 for the remaining $80 balance. The adjusted claim shows that the health plan 102 should have paid $80 and the HSA portion was only $20. Since the net adjusted claim payment to the health care provider 110 of $100 equals the original claim payment, the HCO 100 does not make any additional payments to the health care provider 110. Instead, the HCO 100 refunds the member 108 $60, records an additional $60 health plan payment at the HCO account 128, and sends a supplemental EOB to both provider and member to indicate the change in the amount of money being paid from the health plan 102 versus the HSA.

However, if, in step 336, the net adjustment is an HSA overpayment, the HCO 100 pursues the HSA overpayment from the health care provider 110, step 338, and issues a supplemental EOB to reflect the adjusted balances, step 320. For example, the HCO 100 originally allocates $20 to the health plan portion of the combined $100 payment to the health care provider 110 and automatically debits the HSA account 104 for $80. The adjusted claim indicates that the HCO 100 should have paid $60 and the HSA $20. In this case, the HCO 100 refunds the member 108 $60 and records an additional $60 benefit plan payment, while pursuing the $20 from the health care provider 110.

Finally, if, in step 340, the claim processing module 101 identifies a net plan underpayment, the HCO 100 issues a second payment to the health care provider 110, step 342, and issues a supplemental EOB to reflect the changes in member's and HCO's balances under the claim, step 320.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of administering payments under a health plan by a health care organization, the health plan associated with a financial account administered by a financial institution for a health plan member for making health care related payments, the method comprising:
receiving a medical claim associated with the health plan member, the medical claim comprising a description of charges;
determining a first amount comprising the health care organization's responsibility for payment for the medical claim under the health plan;
determining a second amount comprising the health plan member's responsibility for payment for the medical claim under the health plan;
interfacing with a financial institution for sending an electronic request to debit the health plan member's financial account for the second amount when the description of charges relates to at least one of medical products and medical services;
in response to electronically receiving the second amount from the financial institution, issuing a first payment for the medical claim to a health care provider, the payment including the first and second amounts;
receiving an adjustment request to adjust the first payment due to at least one of an overpayment and an underpayment associated with at least one of the first and second amounts; and
in response to the adjustment request, adjusting at least one of the first and second amounts to eliminate the overpayment and the underpayment by interfacing with the financial institution.

2. The method of claim 1 wherein the adjustment is selected from the group consisting of balancing the first and second amounts to adjust for a change in the health care organization's and health plan member's responsibilities, issuing a second payment to the health care provider to adjust for the underpayment to the health care provider, crediting the health plan member's financial account to adjust for the overpayment from the financial account, and issuing a collection request to the health care provider to adjust for the overpayment to the health care provider.

3. The method of claim 1 wherein the health plan is a high deductible health plan and the financial account is an HSA account.

4. The method of claim 1 further comprising receiving an input from the health plan member to permit the health care organization to interface with the financial institution for sending the electronic request, wherein the health care organization is capable of receiving the input throughout a health plan year.

5. The method of claim 1 further comprising issuing an explanation of benefits statement reflecting the first and second amounts.

6. The method of claim 5 further comprising issuing a supplemental explanation of benefits statement reflecting the adjustment.

7. A system for administering payments under a health plan by a health care organization, the system comprising:
a financial account administered by a financial institution for a health plan member, the financial account adapted for making health care related payments;
a claim processing module associated with the health care organization, the claim processing module capable of interfacing with the financial account for sending a request to electronically debit the financial account for the health plan member's responsibility for a payment in connection with a medical claim under the health plan and adjusting at least the health plan member's responsibility for the payment to eliminate at least one of an overpayment and an underpayment associated with the health plan member's responsibility for the payment by transferring funds in and out of the financial account.

8. The system of claim 7 wherein the claim processing module transfers funds in and out of the financial account via an electronic funds transfer.

9. The system of claim 7 wherein the adjustment is selected from the group consisting of balancing the health plan member's and the health care organization's respective responsibilities for the payment to adjust for a change in the respective responsibilities, issuing a payment to the health care provider to adjust for an underpayment to the health care provider, crediting the health plan member's financial account to adjust for the overpayment associated with the health plan member's responsibility, and issuing a collection request to the health care provider to adjust for an overpayment to the health care provider.

10. The system of claim 7 wherein the health plan is a high deductible health plan and the financial account is an HSA account.

11. The system of claim 7 further comprising an online interface for receiving an input from the health plan member to permit the health care organization to interface with the financial institution for sending an electronic request to transfer funds in and out of the financial account, wherein the health care organization is capable of receiving the input throughout a health plan year.

12. The system of claim 7 wherein the claim processing module issues an explanation of benefits statement reflecting the health plan member's and the health care organization's respective responsibilities for the payment.

13. The system of claim 12 wherein the claim processing module issues a supplemental explanation of benefits statement reflecting an adjustment to the health plan member's and the health care organization's respective responsibilities for the payment.

14. A computer readable medium having stored thereon computer executable instructions for administering payments under a health plan by a health care organization, the health plan associated with a financial account administered by a financial institution for a health plan member for making health care related payments, the instructions comprising:
receiving a medical claim associated with the health plan member, the medical claim comprising a description of charges;
determining a first amount comprising the health care organization's responsibility for payment for the medical claim under the health plan;
determining a second amount comprising the health plan member's responsibility for payment for the medical claim under the health plan;
interfacing with a financial institution for sending an electronic request to debit the health plan member's financial account for the second amount when the description of charges relates to at least one of medical products and medical services;
in response to electronically receiving the second amount from the financial institution, issuing a first payment for the medical claim to a health care provider, the payment including the first and second amounts;
receiving an adjustment request to adjust the first payment due to at least one of an overpayment and an underpayment associated with at least one of the first and second amounts; and
in response to the adjustment request, adjusting the at least one of the first and second amounts to eliminate the overpayment and the underpayment by interfacing with the financial institution.

15. The computer readable medium of claim 14 wherein the adjustment instruction is selected from the group consisting of balancing the first and second amounts to adjust for a change in the health care organization's and health plan member's responsibilities, issuing a second payment to the health care provider to adjust for the underpayment to the health care provider, crediting the health plan member's financial account to adjust for the overpayment from the financial account, and issuing a collection request to the health care provider to adjust for the overpayment to the health care provider.

16. The computer readable medium of claim 14 wherein the health plan is a high deductible health plan and the financial account is an HSA account.

17. The computer readable medium of claim 14 further comprising instructions for receiving an input from the health plan member to permit the health care organization to interface with the financial institution for sending the electronic request, wherein the health care organization is capable of receiving the input throughout a health plan year.

18. The computer readable medium of claim 17 wherein the instructions further comprise receiving the input via an online interface.

19. The computer readable medium of claim 14 wherein the instructions further comprise issuing an explanation of benefits statement reflecting the first and second amounts.

20. The computer readable medium of claim 19 wherein the instructions further comprise issuing a supplemental explanation of benefits statement reflecting the adjustment.
